(19) United States
(12) Patent Application Publication
(10) Pub. No.: US 2011/0117475 A1
(43) Pub. Date: May 19, 2011

(54) Anode supported solid oxide fuel cell

(76) Inventors: Duk-Hyoung Yoon, Suwon-si (KR); Sang-Jun Kong, Suwon-si (KR); Tae-Ho Kwon, Suwon-si (KR)

(21) Appl. No.: 12/662,988

(22) Filed: May 14, 2010

(30) Foreign Application Priority Data
Nov. 17, 2009 (KR) 10-2009-0110771

(51) Int. Cl. H01M 8/10

(52) U.S. Cl. 429/495

(57) ABSTRACT

An anode supported solid oxide fuel cell including a cylinder-type anode, the cylinder-type anode having a hollow part therein; an electrolyte and an air gap sequentially laminated on an outer peripheral surface of the anode; and a plurality of conductors in the hollow part, the conductors being capable of current collecting in the cell.

### BACKGROUND

1. Field

Embodiments relate to an anode supported solid oxide fuel cell, and more particularly, to.

2. Discussion of Related Art

A fuel cell as a cell directly converting chemical energy generated by oxidation into electric energy is a new environmentally friendly future energy technology that generates electric energy from a material found abundantly in the earth, e.g., hydrogen and oxygen.

An electrochemical reaction may proceed as an electrolysis reverse reaction pattern occasioned by supplying the oxygen to a cathode of the fuel cell and fuel gas to an anode of the fuel cell, such that electricity, heat, and water are generated so as to generate the electric energy with high efficiency while preventing pollution from being caused.

Since a fuel cell may be free from limitations associated with the Carnot Cycle, i.e., the limitations of a typical heat engine, efficiency may be increased by about 40% or more. Since a fuel cell discharges only water, there may be little worry about pollution. Further, unlike typical heat engines, since the fuel cell includes no mechanically moving parts, the fuel cell may be miniaturized and may not generate noise. As described above, the fuel cell may have various advantages.

An electrochemical reaction in an anode electrode and a cathode electrode in a typical fuel cell may be represented by Reaction Formula 1, below:

Anode electrode: 2H₂→4H⁺+4e−

Cathode electrode: O₂+4e−+4H⁺→2H₂O [Reaction Formula 1]

Hydrogen may be supplied to the anode electrode and decomposed into hydrogen ions and electrons. The hydrogen ions may move to the cathode electrode through an electrolyte membrane, and the electrons may move to the cathode electrode through an external wire to thereby generate electric power. Oxygen contained in air may be supplied to the cathode electrode. The electrons and hydrogen ions from the anode electrode and the oxygen may react with each other in the cathode electrode to generate water.

The fuel cell may be classified into, e.g., a phosphoric acid fuel cell (PAFC), a molten carbonate fuel cell (MCFC), a solid oxide fuel cell (SOFC), a polymer electrolyte membrane fuel cell (PEMFC), a direct methanol fuel cell (DMFC), and an alkaline fuel cell (AFC), depending on the kind of an electrolyte.

Since the above-mentioned fuel cells vary in output range and usage, the type fuel cell may be selected depending on an intended purpose. Of them, the solid oxide fuel cell may have a high operating temperature but may exhibit high efficiency and current density, e.g., approximately 45%, thereby having an advantage of being suitable for large-scale power generation.

### SUMMARY

Embodiments are directed to an anode supported solid oxide fuel cell, which represents advances over the related art.

It is a feature of an embodiment to provide an anode supported solid oxide fuel cell capable of improving current collecting efficiency by reducing resistance through substituting a metal tube formed in the cell with a conductor, in order to transport hydrogen gas and collect current.

It is another feature of an embodiment to provide an anode supported solid oxide fuel cell capable of remarkably increasing productivity by simplifying a manufacturing process through substituting a felt layer formed on the inner peripheral surface of an anode with a conductor in order to improve the current collecting efficiency of the fuel cell.

At least one of the above and other features and advantages may be realized by providing an anode supported solid oxide fuel cell including a cylinder-type anode, the cylinder-type anode having a hollow part therein; an electrolyte and an air gap sequentially laminated on an outer peripheral surface of the anode; and a plurality of conductors in the hollow part, the conductors being capable of current collecting in the cell.

The anode supported solid oxide fuel cell may further include a catalyst in the hollow part.

The anode supported solid oxide fuel cell may further include a metal member in the hollow part, the metal member increasing a contact area among the plurality of conductors.

The metal member may be a metal sheet, the metal sheet connecting the conductors.

The metal member may be a metal mesh, the metal mesh arranging the conductors at a regular interval.

The metal member may be cross (+)-shaped in transverse cross-section.

The anode supported solid oxide fuel cell may further include a gas distributor in an inlet path.

The conductors may include a metal having melting point of about 800° C. or higher.

The anode supported solid oxide fuel cell may further include a metal layer on an inner peripheral surface of the anode.

The metal layer may include Ni.

The anode supported solid oxide fuel cell may further include a catalyst in the hollow part.

The anode supported solid oxide fuel cell may further include a metal member in the hollow part, the metal member increasing a contact area among the plurality of conductors.

The metal member may be a metal sheet, the metal sheet connecting the conductors.

The metal member may be a metal mesh, the metal mesh arranging the conductors at a regular interval.

The metal member may be cross (+)-shaped in transverse cross section.

The anode supported solid oxide fuel cell may further include a gas distributor in an inlet path.

The conductors may include a metal having melting point of about 800° C. or higher.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a cross-sectional view of an anode supported solid oxide fuel cell;

FIG. 2 illustrates a cross-sectional view of an anode supported solid oxide fuel cell according to an embodiment;

FIG. 3 illustrates a cross-sectional view of a solid oxide fuel cell according to another embodiment;

FIG. 4 illustrates a cross-sectional view of a solid oxide fuel cell according to yet another embodiment;

FIG. 5A illustrates a cross-sectional view of a solid oxide fuel cell according to still another embodiment;

FIG. 5B illustrates a cross-sectional view of a solid oxide fuel cell according to still another embodiment;

FIG. 5C illustrates a cross-sectional view of a solid oxide fuel cell according to still another embodiment; and

FIG. 6 illustrates a cross-sectional view of a solid oxide fuel cell according to still another embodiment.

### DETAILED DESCRIPTION

Korean Patent Application No. 10-2009-0110771, filed on Nov. 17, 2009, in the Korean Intellectual Property Office, and entitled: “Anode Supported Solid Oxide Fuel Cell” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. Like reference numerals refer to like elements throughout.

In the following detailed description, only certain embodiments have been shown and described, simply by way of illustration. As those skilled in the art would realize, the described embodiments may be modified in various different ways, all without departing from the spirit or scope. Accordingly, the drawings and description are to be regarded as illustrative in nature and not restrictive.

Hereinafter, the above-mentioned anode supported solid oxide fuel cell 100 will be described in detail with reference to the accompanying drawings.

FIG. 2 illustrates a cross-sectional view of an anode supported solid oxide fuel cell according to an embodiment. As illustrated in FIG. 2, a solid oxide fuel cell 100 may include a cylinder-type anode 101 as a support. The solid oxide fuel cell 100 may also include an electrolyte 102 and an air gap 103 sequentially laminated on an outer peripheral surface of the anode 101. The solid oxide fuel cell 100 may have a hollow part 107 in the anode 101. A plurality of conductors 105 for current collecting in the cell may be inserted into the hollow part 107.

The plurality of conductors 105 in the hollow part 107 may replace, i.e., may serve the same function as, a conventional metal tube and felt layer in the cell for, e.g., transporting hydrogen gas and collecting current, thus improving current collecting efficiency. The conductor 105 may be made of metal having melting temperature of about 800° C. or greater, e.g., Ni. The conductor 105 may be formed in various shapes and sizes, e.g., a spherical type, an elliptical type, a cubic type, and/or a polygonal type, depending on characteristics of the solid oxide fuel cell 100.

If a metal tube made of, e.g., SUS, is used as a current collecting member, resistance may increase. As a result, the current collecting efficiency of the fuel cell may be deteriorated. If the felt layer is formed on the inner peripheral surface of the anode in order to improve the current collecting efficiency, the current collecting efficiency may indeed be improved; however a manufacturing process thereof may be difficult due to the manual process for forming the felt layer, thereby deteriorating productivity.

The anode supported solid oxide fuel cell 100 according to an embodiment may have an advantage in that the plurality of conductors 105 may be inserted into the hollow part 107 for current collecting in the cell, thus improving the current collecting efficiency by reducing the resistance while also simplifying the manufacturing process.

FIG. 3 illustrates a cross-sectional view of a solid oxide fuel cell 100 according to another embodiment. The solid oxide fuel cell 100 may include a metal layer 208 on an inner peripheral surface of the anode 101. Inclusion of the metal layer 208 may further improve current collecting ability. In an implementation, a single metal, e.g., Ni, may be used as the metal layer.

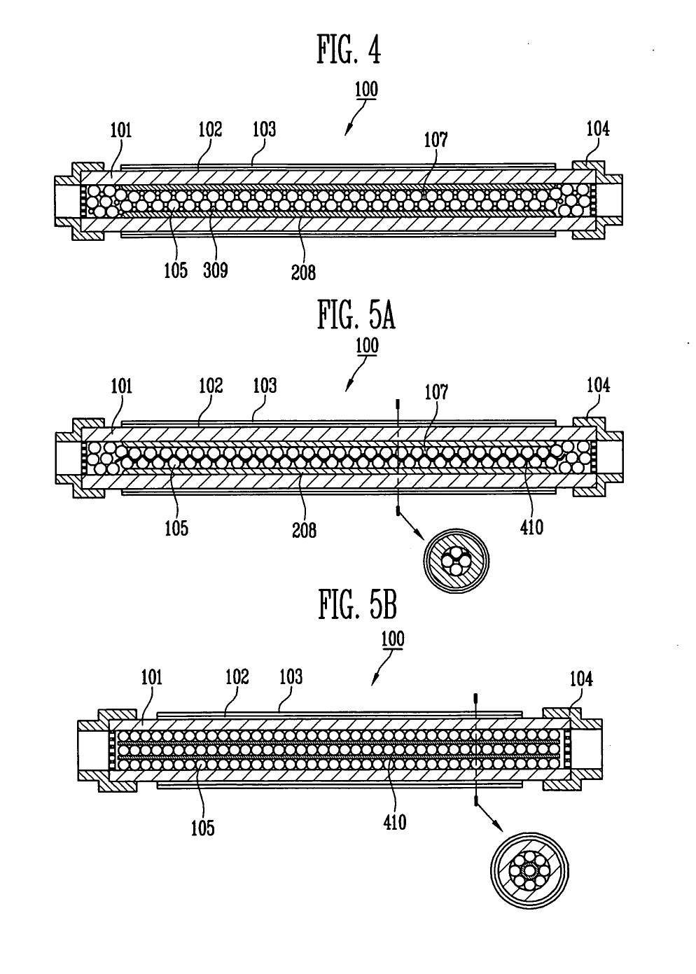

FIG. 4 illustrates cross-sectional view of a solid oxide fuel cell 100 according to yet another embodiment. In the solid oxide fuel cell 100 according to the present embodiment, a catalyst 309 may also be inserted into the hollow part 107.

The solid oxide fuel cell 100 according to such embodiment may have the advantage of being capable of increasing a reforming effect of unreacted gas in a reformer by additionally including the catalyst in the hollow part 107 along with the conductor 105.

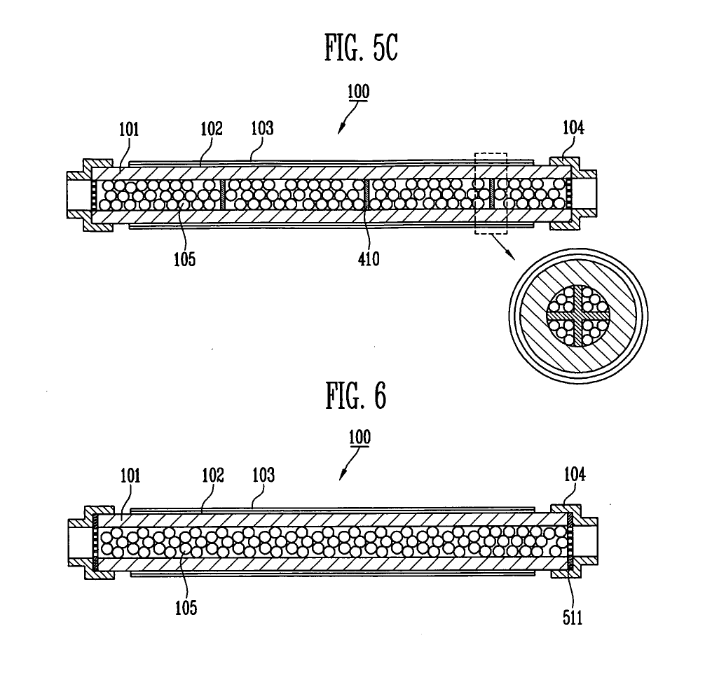

FIGS. 5A to 5C illustrate cross-sectional views of solid oxide fuel cells 100 according to more embodiments. A metal member 410 for increasing contact area among the plurality of conductors 105 may also be inserted in the hollow part 107. The contact area among the conductors 105 may be increased by inclusion of the metal member 410, thereby further reducing resistance.

FIG. 5A illustrates a solid oxide fuel cell 100 including the metal member 410 in the form of a metal sheet that connects, i.e., electrically connects, the conductors 105. FIG. 5B illustrates a solid oxide fuel cell 100 including the metal member 410 in the form of a metal mesh that arranges the conductors at a regular interval. FIG. 5C illustrates a solid oxide fuel cell 100 including the metal member 410 in the form of a Metal member that is cross (+)-shaped in transverse cross-section. In other implementations, the metal member 410 may be formed in various sizes and shapes depending on the size of the solid oxide fuel cell 100 and the characteristics of the anode 101.

FIG. 6 illustrates cross-sectional view of a solid oxide fuel cell 100 according to still another embodiment. In the solid oxide fuel cell 100 according to such embodiment, a gas distributor 511 may be formed in a gas inlet path.

In the solid oxide fuel cell 100 according to the embodiment of FIG. 6, the gas distributor 511 may evenly supply the hydrogen gas, thereby improving reactivity.

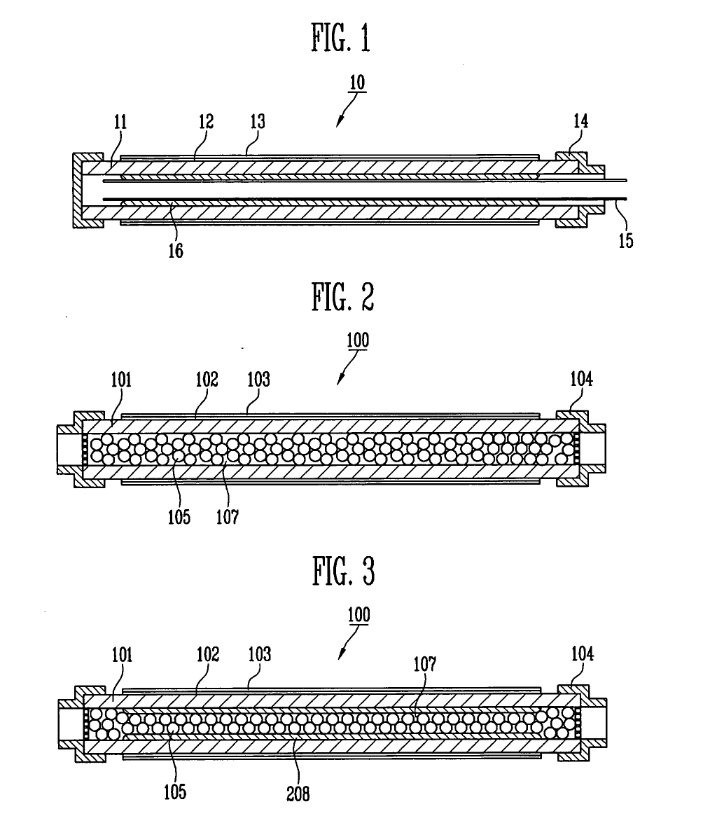

A solid oxide fuel cell may be classified into a plate type and a cylinder type cell. FIG. 1 illustrates a cylinder-type solid oxide fuel cell 10 using an anode as a support. As illustrated in FIG. 1, in an anode supported solid oxide fuel cell 10, an anode 11, i.e., fuel electrode, may be used as a support. An electrolyte 12 and an air gap 13 may be sequentially laminated on an outer peripheral surface of the anode 11. In addition, a sealing cap 14 may be formed at one side of the support of the anode 11. Further, a metal tube 15 made of, e.g., stainless steel (SUS), as a current collecting member, may be formed in the fuel cell in order to supply hydrogen to the anode 11 and/or to collect current. Further, a felt layer 16 made of a conductive material, e.g., Ni, may be formed on an inner peripheral surface of the anode 11 for internal current collecting in the cell.

However, the anode supported solid oxide fuel cell 10 using the metal tube 15 as the current collecting member may result in resistance being increased. Hence, the current collecting efficiency of the fuel cell may be deteriorated. Further, if the felt layer 16 is formed on the inner peripheral surface of the anode 11, in order to improve the current collecting efficiency of the fuel cell, the manufacturing process thereof may be difficult stemming from the manual process for forming the felt layer, thereby deteriorating productivity. By contrast, the present anode supported solid oxide fuel cell may exhibit decreased resistance therein, thereby exhibiting superior current collecting efficiency. Further, the manufacturing process thereof may be simplified because the difficult-to-form felt layer is eliminated.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An anode supported solid oxide fuel cell, comprising:
a cylinder-type anode, the cylinder-type anode having a hollow part therein;
an electrolyte and an air gap sequentially laminated on an outer peripheral surface of the anode; and
a plurality of conductors in the hollow part, the conductors being capable of current collecting in the cell.

2. The anode supported solid oxide fuel cell as claimed in claim 1, further comprising a catalyst in the hollow part.

3. The anode supported solid oxide fuel cell as claimed in claim 1, further comprising a metal member in the hollow part, the metal member increasing a contact area among the plurality of conductors.

4. The anode supported solid oxide fuel cell as claimed in claim 3, wherein the metal member is a metal sheet, the metal sheet connecting the conductors.

5. The anode supported solid oxide fuel cell as claimed in claim 3, wherein the metal member is a metal mesh, the metal mesh arranging the conductors at a regular interval.

6. The anode supported solid oxide fuel cell as claimed in claim 3, wherein the metal member is cross (+)-shaped in transverse cross-section.

7. The anode supported solid oxide fuel cell as claimed in claim 1, further comprising a gas distributor in an inlet path.

8. The anode supported solid oxide fuel cell as claimed in claim 1, wherein the conductors include a metal having melting point of about 800° C. or higher.

9. The anode supported solid oxide fuel cell as claimed in claim 1, further comprising a metal layer on an inner peripheral surface of the anode.

10. The anode supported solid oxide fuel cell as claimed in claim 9, wherein the metal layer includes Ni.

11. The anode supported solid oxide fuel cell as claimed in claim 9, further comprising a catalyst in the hollow part.

12. The anode supported solid oxide fuel cell as claimed in claim 9, further comprising a metal member in the hollow part, the metal member increasing a contact area among the plurality of conductors.

13. The anode supported solid oxide fuel cell as claimed in claim 12, wherein the metal member is a metal sheet, the metal sheet connecting the conductors.

14. The anode supported solid oxide fuel cell as claimed in claim 12, wherein the metal member is a metal mesh, the metal mesh arranging the conductors at a regular interval.

15. The anode supported solid oxide fuel cell as claimed in claim 12, wherein the metal member is cross (+)-shaped in transverse cross section.

16. The anode supported solid oxide fuel cell as claimed in claim 9, further comprising a gas distributor in an inlet path.

17. The anode supported solid oxide fuel cell as claimed in claim 9, wherein the conductors include a metal having melting point of about 800° C. or higher.
